(19) United States
(12) Patent Application Publication
(10) Pub. No.: US 2016/0360916 A1
(43) Pub. Date: Dec. 15, 2016

(54) STEAM GENERATING DEVICE AND THERMAL COOKING APPARATUS

(71) Applicant: SHARP KABUSHIKI KAISHA, Sakai City, Osaka (JP)

(72) Inventors: Takashi UTSUMI, Sakai-shi (JP); Masayuki UNO, Sakai-shi (JP); Shinya UEDA, Sakai-shi (JP)

(21) Appl. No.: 15/121,078

(22) PCT Filed: Jun. 9, 2015
(86) PCT No.: PCT/JP2015/066632

§ 371 Date: Aug. 24, 2016

(30) Foreign Application Priority Data
Jun. 27, 2014 (JP) 2014-132983

(51) Int. Cl. A47J 27/04

(52) U.S. Cl. CPC A47J 27/04; A47J 2027/043

(57) ABSTRACT

A steam generating device (100) includes a heat source (103), a steam generating container (101) made of a metal having the heat source (103) cast therein, and a lid portion (102) covering an upper opening of the steam generating container (101) and forming a steam generating space (P1) together with the steam generating container (101).

### TECHNICAL FIELD

The present invention relates to steam generating devices and thermal cooking apparatuses.

### BACKGROUND ART

Conventionally, there is a thermal cooking apparatus including a steam generating device for generating steam to be supplied to a heating chamber (for example, see JP 2012-255644 A (PTL 1)). The steam generating device of the thermal cooking apparatus includes a metallic boiler having a heat generating portion embedded by casting and supplies steam generated in a steam generating space in the boiler into the heating chamber.

There is also a steam generating device for generating steam through an evaporating pan which is provided with a cover member in an upper part (for example, see JP 2005-233601 A (PTL 2)).

### CITATION LIST

### Patent Literature

PTL 1: JP 2012-255644 A

PTL 2: JP 2005-233601 A

### SUMMARY OF THE INVENTION

### Technical Problem

Referring to the steam generating device described in PTL 1, water droplets are evaporated so that scale is deposited on the wall surface in the boiler heated to a high temperature through the heat generating portion. Consequently, there is a problem in that a heating efficiency is reduced. Referring to the steam generating device, the heating efficiency is reduced due to the scale deposited in the boiler. For this reason, a steam rise is deteriorated or a necessary amount of steam cannot be obtained, and furthermore, evaporation cannot be performed sufficiently so that the water droplets and/or the scale are blown out and scattered into the heating chamber together with the steam and the water droplets and/or scale adheres to an object to be heated, which is insanitary.

Referring to the steam generating device of the thermal cooking apparatus described in PTL 2, the ceramic cover member is provided in the upper part of the pan-shaped steam generating device. In the case in which a large amount of steam is used to perform cooking, however, it is necessary to generate the large amount of steam from the steam generating device. In that case, a large amount of foamy boiling water having high viscosity is generated with the generation of the scale. Many conventional thermal cooking apparatuses prevent the foamy boiling water from entering a heating chamber by ensuring a height from a place in the steam generating device where steam is generated to an outlet for discharging the steam to the outside of the steam generating device to some degree.

Therefore, it is an object of the present invention to provide steam generating devices capable of suppressing generation of scale and a reduction in the heating efficiency, and also provide thermal cooking apparatuses using the same.

### Solution to Problem

A steam generating device according to an aspect of the present invention includes:

a heat source;

a steam generating container made of a metal having the heat source cast therein; and

a lid portion covering an upper opening of the steam generating container and forming a steam generating space P1 together with the steam generating container,

the lid portion being made of a heat resistant resin or a portion between the steam generating container and the lid portion being heat insulated by a heat insulating member.

In a steam generating device according to an embodiment, the lid portion has a protrusion provided on an upper side thereof and a steam outlet provided at an end of the protrusion, and the steam generating device further includes, within the lid portion and at a lower side of the protrusion, a boiling water shielding wall provided in a region opposed to both the protrusion and a shoulder portion in the vicinity of the protrusion and serving to block boiling water from the steam generating container.

A steam generating device according to an embodiment further includes a water level sensor arranged to detect a water level in the steam generating container; and a water level detecting chamber cover provided in the steam generating space P1 and forming a water level detecting chamber to surround the water level sensor.

In a steam generating device according to an embodiment, a water supply/discharge port through which water is to be supplied into and discharged from the steam generating container is provided in the steam generating container.

A steam generating device according to an embodiment further includes a heat insulating cover formed at a distance with respect to the steam generating container so as to cover the steam generating container and fixed to the lid portion.

A steam generating device according to an embodiment further includes a heat insulating cover formed at a distance with respect to the steam generating container so as to cover the steam generating container and fixed to the lid portion.

A thermal cooking apparatus according to an aspect of the present invention includes any one of the above-described steam generating devices; and a heating chamber to which steam fed from the steam generating device is supplied.

A thermal cooking apparatus according to an embodiment further includes an attaching member by which the steam generating container of the steam generating device is attached through the lid portion to the heating chamber or to an attached member provided on a side of the heating chamber.

A thermal cooking apparatus according to an embodiment includes:

a heating chamber to which steam fed from the steam generating device is to be supplied;

a body casing in which the heating chamber is accommodated; and

a cooling fan arranged to cool an electrical component in the body casing,

wherein the heat insulating cover of the steam generating device has an opening portion opened toward a downstream side of cooling air fed from the cooling fan, the opening portion serving to lead, to an outside, a power supplying portion of the heat source cast into the steam generating container.

### Advantageous Effects of Invention

As is apparent from the above, according to the present invention, the upper opening of the steam generating container made of metal having the heat source cast therein is covered with the lid portion made of a heat resistant resin (or the lid portion thermally insulated from the steam generating device), and the steam generating space is formed by the steam generating container and the lid portion. As a result, it is possible to achieve a steam generating device in which generation of scale and a reduction in the heating efficiency are suppressed, and a thermal cooking apparatus using such a steam generating device.

### BRIEF DESCRIPTION OF THE DRAWINGS

FIG. 1 is a schematic front view of a thermal cooking apparatus, with its door closed, using a steam generating device according to a first embodiment of the invention;

FIG. 2 is a schematic front view of the thermal cooking apparatus, with its door opened;

FIG. 3 is a schematic view for explaining a main-part structure of the thermal cooking apparatus;

FIG. 4 is a schematic view for explaining a structure of other parts of the thermal cooking apparatus;

FIG. 5 is a control block diagram of the thermal cooking apparatus;

FIG. 6 is a top view showing a steam generating device of the thermal cooking apparatus;

FIG. 7 is a side view showing the steam generating device;

FIG. 8 is a sectional view as seen from an XIII-XIII line of FIG. 6;

FIG. 9 is a side view showing the steam generating device illustrated in FIG. 7 as seen from a left-hand side;

FIG. 10 is a sectional view seen from an X-X line in FIG. 6;

FIG. 11 is a perspective view showing a cover for a water level detecting chamber of the steam generating device;

FIG. 12 is a top view showing a steam generating device using an attaching member;

FIG. 13 is a side view showing the steam generating device using the attaching member;

FIG. 14 is a sectional view showing a steam generating device according to a fourth embodiment of the present invention;

FIG. 15 is a sectional view showing a certain part of the steam generating device according to the fourth embodiment of the present invention;

FIG. 16 is a view showing a state in which a cover for a water level detecting chamber is removed from the part;

FIG. 17 is a view showing a state in which the cover for the water level detecting chamber is attached to the part; and

FIG. 18 is a perspective view showing the cover for the water level detecting chamber.

### DESCRIPTION OF EMBODIMENTS

Steam generating devices and thermal cooking apparatuses using the same according to the present invention will be described below in detail based on embodiments shown in the drawings.

### First Embodiment

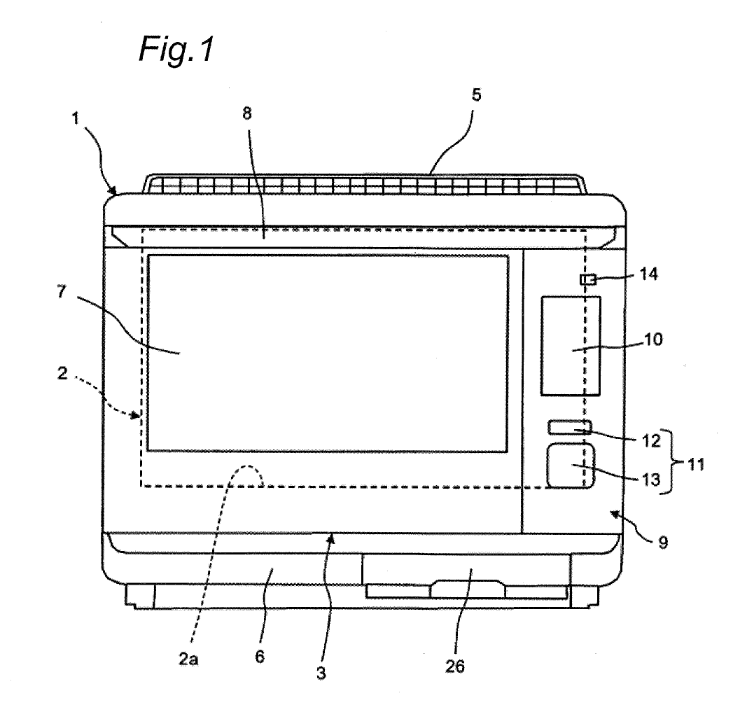

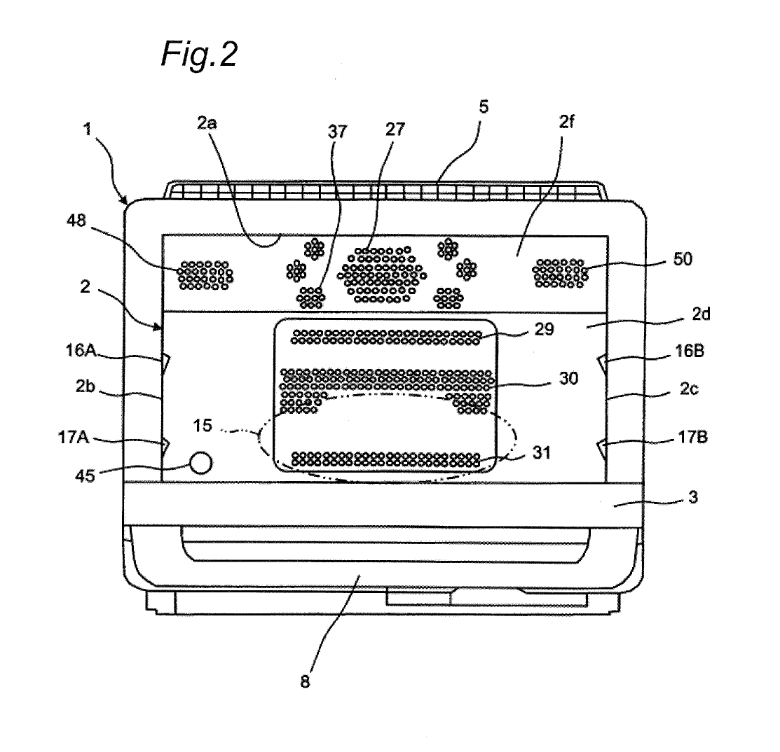

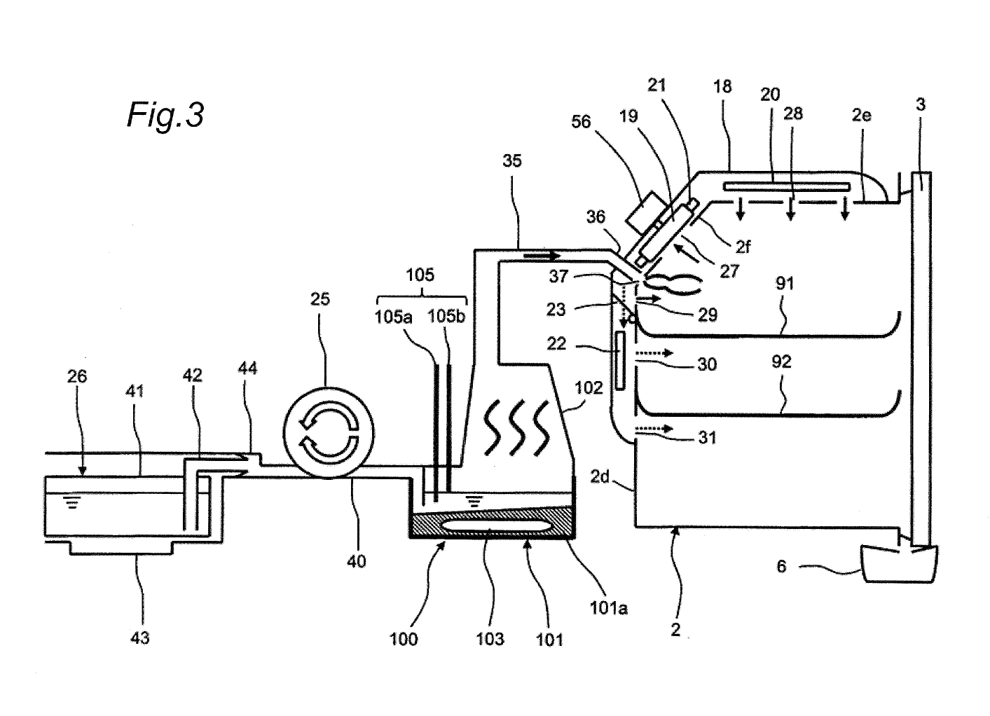

FIG. 1 is a schematic front view of a thermal cooking apparatus, with its door closed, using a steam generating device 100 (shown in FIG. 3) according to a first embodiment of the present invention. FIG. 2 is a schematic front view of the thermal cooking apparatus with its door opened.

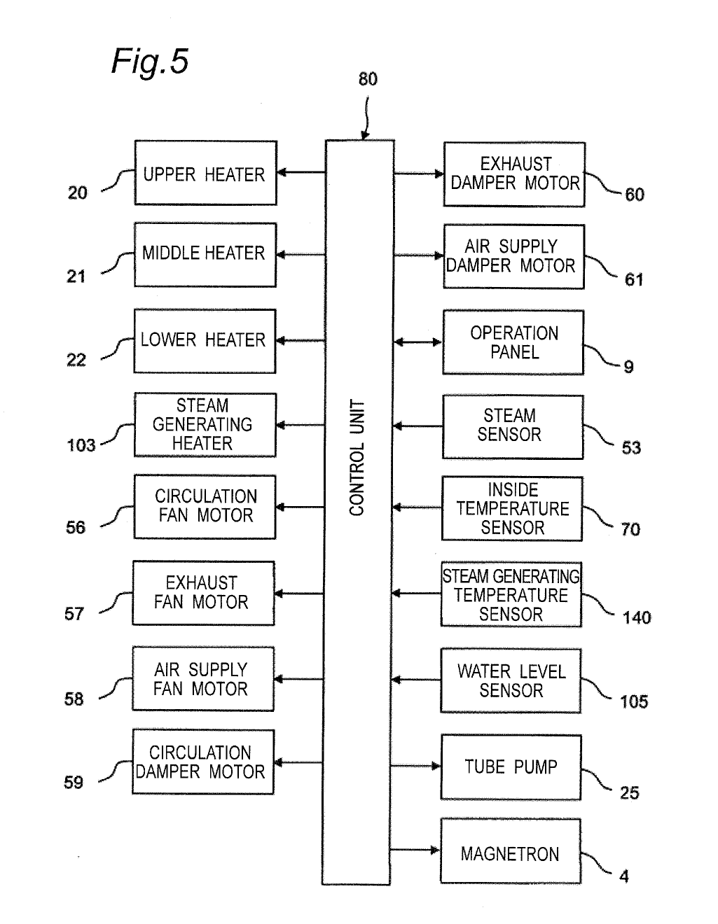

The thermal cooking apparatus according to the first embodiment includes a body casing 1 having a shape of a rectangular parallelepiped, a heating chamber 2 provided in the body casing 1 and having an opening portion 2a on its front side, a door 3 arranged to open and close the opening portion 2a of the heating chamber 2, and a magnetron 4 (shown in FIG. 5) arranged to supply microwaves into the heating chamber 2 in which a food is to be accommodated as shown in FIGS. 1 and 2. The magnetron 4 is an example of a microwave generator.

An exhaust duct 5 is provided in a rear part of an upper surface of the body casing 1. A dew receiver 6 is removably attached to a lower part of a front surface of the body casing 1. The dew receiver 6 is positioned below the door 3 and is enabled to receive water droplets from a rear surface of the door 3 (a surface on the heating chamber 2 side). A water supply tank 26 which will be described below is also attached removably in the lower front of the body casing 1.

The door 3 is attached at the front surface side of the body casing 1 so as to be rotatable with a lower side of the door set to be an axis of rotation. A front surface of the door 3 (a surface at an opposite side to the heating chamber 2) is provided with a transparent outer glass 7 which is heat resistant. The door 3 has a handle 8 positioned above the outer glass 7 and an operation panel 9 provided at a right side of the outer glass 7.

The operation panel 9 has a color liquid crystal display portion 10 and a button group 11. The button group 11 includes a cancel key 12 to be pressed down when stopping heating halfway or at other occasions, and a warming start key 13 to be pressed when starting heating. The operation panel 9 is provided with an infrared ray receiving portion 14 for receiving infrared rays from a smartphone or the like.

A substance 15 to be heated is accommodated in the heating chamber 2. Metallic cooking trays 91 and 92 (shown in FIG. 3) can be put in/out of the heating chamber 2. Internal surfaces of a left side portion 2b and a right side portion 2c in the heating chamber 2 are provided with upper tray holders 16A and 16B for supporting the cooking tray 91. Furthermore, lower tray holders 17A and 17B for supporting the cooking tray 92 are provided on the internal surfaces of the right side portion 2c and the left side portion 2b in the heating chamber 2 so as to be positioned below the upper tray holders 16A and 16B.

The cooking trays 91 and 92 have a gap against a rear portion 2d of the heating chamber 2 when they are disposed in the heating chamber 2. In more detail, contact portions (not shown) are provided at rear end portions of the upper tray holders 16A, 16B and the lower tray holders 17A, 17B, respectively. These contact portions come into contact with the cooking trays 91, 92 before those cooking trays 91, 92 come into contact with the rear portion 2d of the heating chamber 2 so that rearward movement of the cooking trays 91, 92 is restricted. At this time, a gap having a length in a longitudinal (front-and-rear) direction, for example, 3 mm may be generated between the cooking trays 91 and 92 and the rear portion 2d of the heating chamber 2.

FIG. 3 is a schematic view for explaining a structure of a main part of the thermal cooking apparatus. FIG. 3 shows a state in which the heating chamber 2 is seen from a left side. In FIG. 3, 3 denotes a door and 6 denotes a dew receiver.

The thermal cooking apparatus includes a circulation duct 18, a circulation fan 19, an upper heater 20, a middle heater 21, a lower heater 22, a circulation damper 23, a tube pump 25, a water supply tank 26 and the steam generating device 100. The upper heater 20, the middle heater 21 and the lower heater 22 each are provided in the form of a sheath heater, for example. The circulation duct 18 is an example of the duct. Furthermore, the circulation damper 23 is an example of the damper. The tube pump 25 is an example of the pump. In the present invention, the pump is not limited to the tube pump, but is only required to be a pump capable of switching between a water supplying operation and a water discharging operation depending on a driving direction.

An upper part 2e of the heating chamber 2 communicates with the rear portion 2d of the heating chamber 2 through an inclined portion 2f which is inclined with respect to a horizontal direction. The inclined portion 2f is provided with a plurality of suction ports 27 which are opposed to the circulation fan 19 (see FIG. 2). Also, a plurality of upper outlets 28 is provided in the upper part 2e of the heating chamber 2. Furthermore, the rear portion 2d of the heating chamber 2 is provided with first rear outlets 29, second rear outlets 30, and third rear outlets 31 (see FIG. 2). The first rear outlet 29 is an example of the outlet. FIG. 3 shows only three of the suction ports 27. In addition, FIG. 3 shows only one of the first rear outlets 29, one of the second rear outlets 30 and one of the third rear outlets 31.

The circulation duct 18 communicates with the inside of the heating chamber 2 through the suction ports 27, the upper outlets 28 and the first to third rear outlets 29 to 31. The circulation duct 18 is provided so as to range from the upper side to the rear side of the heating chamber 2 and is extended to take an inverted L shape. A width in a lateral (left-right) direction of the circulation duct 18 is set to be smaller than a width in a lateral direction of the heating chamber 2.

The circulation fan 19 is a centrifugal fan and is driven by a motor 56 for a circulation fan (“circulation fan motor 56”). When the circulation fan motor 56 drives the circulation fan 19, air or saturated steam (which will be hereinafter referred to as “air or the like”) in the heating chamber 2 is sucked through the suction ports 27 into the circulation duct 18 and is caused to flow outward in a radial direction of the circulation fan 19. In more detail, at an upper side of the circulation fan 19, the air or the like flows obliquely upward from the circulation fan 19 and then flows forward from a rear part. On the other hand, at a lower side of the circulation fan 19, the air or the like flows obliquely downward from the circulation fan 19 and then flows downward from an upper part. The air or the like is an example of a heating medium.

The upper heater 20 is disposed in the circulation duct 18 and is opposed to the upper part 2e of the heating chamber 2. The upper heater 20 heats the air or the like flowing to the upper outlets 28.

The middle heater 21 is formed circularly and surrounds the circulation fan 19. The middle heater 21 heats the air or the like supplied from the circulation fan 19 toward the upper heater 20 or heats the air or the like supplied from the circulation fan 19 toward the lower heater 22.

The lower heater 22 is disposed in the circulation duct 18 and is opposed to the rear portion 2d of the heating chamber 2. The lower heater 22 heats the air or the like flowing to the second and third rear outlets 30 and 31.

The circulation damper 23 is provided rotatably in the circulation duct 18 and between the middle heater 21 and the lower heater 22. The rotation of the circulation damper 23 is performed by a motor 59 for the circulation damper (referred to as “circulation damper motor 59” below) (shown in FIG. 5).

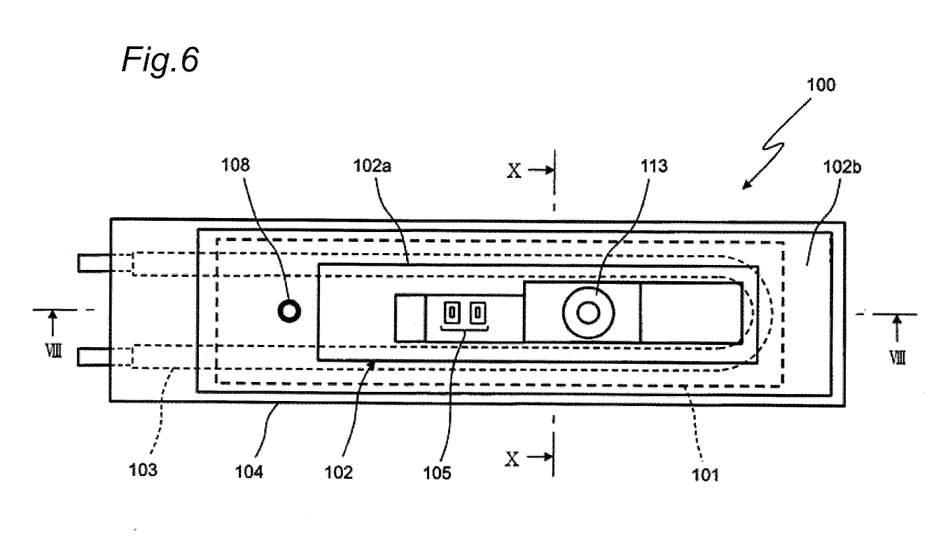

The steam generating device 100 includes a metallic steam generating container 101 having an upper opening, a lid portion 102 formed of a heat resistant resin (for example, a PPS (polyphenylene sulfide) resin) for covering the upper opening of the steam generating container 101, and a steam generating heater 103 provided in the form of a sheath heater cast into a bottom portion 101a of the steam generating container 101 (see FIGS. 6 to 10). Water supplied from the water supply tank 26 is accumulated on the bottom portion 101a of the steam generating container 101 and the steam generating heater 103, which is an example of a heat source, heats the water through the steam generating container 101. Then, saturated steam generated by heating by the steam generating heater 103 flows through a steam tube 35 formed of resin and a metallic steam pipe 36 and is thus supplied into the heating chamber 2 through a plurality of steam supply ports 37 (see FIG. 2). FIG. 3 shows only one of the steam supply ports 37.

The saturated steam in the heating chamber 2 is fed to the upper heater 20, the middle heater 21 and the lower heater 22 by the circulation fan 19 so that overheated steam at 100° C. or more is obtained by heating with the upper heater 20, the middle heater 21 and the lower heater 22.

A water level sensor 105 including a pair of electrodes 105a and 105b is attached to the lid portion 102. Based on whether a conduction state is brought between the electrodes 105a and 105b or not, it is decided whether a water level on the bottom portion 101a of the steam generating container 101 reaches a predetermined water level or not.

The tube pump 25 operates so that a water supply/discharge tube 40 made from silicone rubber or the like and elastically deformable is squeezed by a roller (not shown) to cause the water in the water supply tank 26 to flow to the steam generating device 100 or to cause the water in the steam generating device 100 to flow to the water supply tank 26, depending on a driving direction of the roller. The water supply/discharge tube 40 is an example of a water supply path.

The water supply tank 26 has a water supply tank body 41 and a communicating pipe 42. The communicating pipe 42 has one of ends positioned in the water supply tank body 41, while has the other end of the communicating pipe 42 positioned on the outside of the water supply tank 26. When the water supply tank 26 is accommodated in the tank cover 43, the other end of the communicating pipe 42 is connected to the water supply/discharge tube 40 through a tank joint portion 44. In other words, the inside of the water supply tank body 41 communicates with the inside of the steam generating device 100 through the communicating pipe 42 or the like.

The tube pump 25, the water supply tank 26, the water supply/discharge tube 40, the tank cover 43 and the tank joint portion 44 constitute a water supply device.

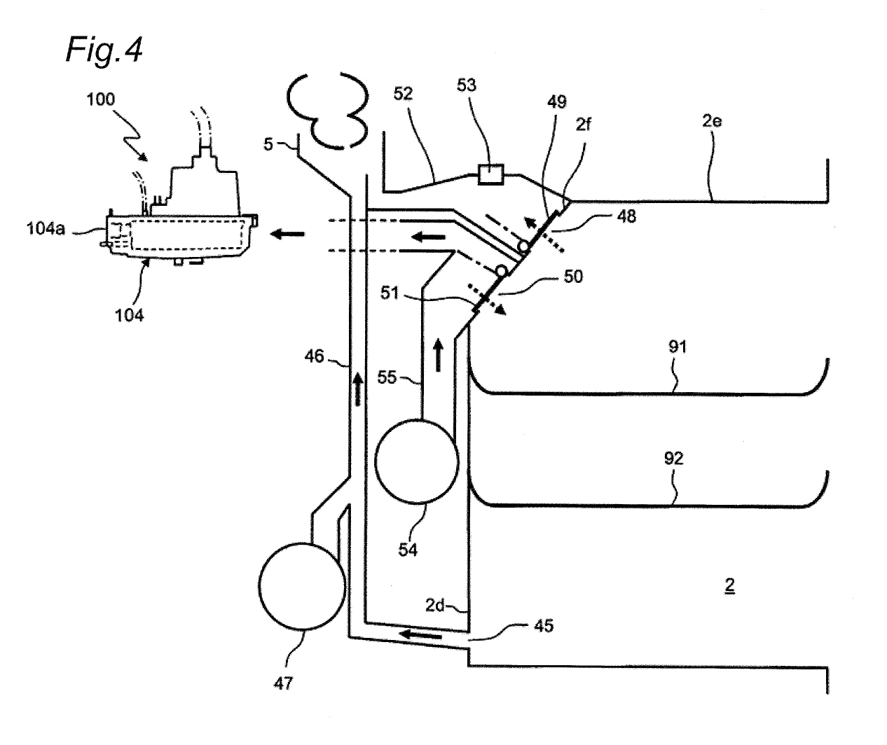

FIG. 4 is a schematic view for explaining a structure of other portions of the thermal cooking apparatus. FIG. 4 also shows a state in which the heating chamber 2 is seen from a right side, as with FIG. 3. In FIGS. 4, 91 and 92 denote cooking trays and 2e denotes an upper part of the heating chamber 2.

A natural exhaust port 45 is provided on a lower end of the rear portion 2d of the heating chamber 2 (see FIG. 2). The natural exhaust port 45 communicates with the exhaust duct 5 through a first exhaust path 46. When the air or the like in the heating chamber 2 is excessive, the excessive air or the like naturally flows out of the natural exhaust port 45 to the first exhaust path 46. An exhaust fan 47 provided in the form of a sirocco fan is connected to the first exhaust path 46, for example.

The inclined portion 2f of the heating chamber 2 is provided with a plurality of forcible exhaust ports 48 to be opened/closed by an exhaust damper 49 and a plurality of air supply ports 50 to be opened/closed by an air supply damper 51 (see FIG. 2). The forcible exhaust ports 48 communicate with the exhaust duct 5 through a second exhaust path 52. On the other hand, the air supply port 50 communicates with a space between the body casing 1 and the heating chamber 2 through the air supply path 55. Furthermore, an air supply fan 54 provided in the form of a sirocco fan, for example, is connected to an air supply path 55. The air supply fan 54 is an example of a cooling fan for cooling electrical components in the body casing 1 (shown in FIGS. 1 and 2).

A steam sensor 53 is attached to the second exhaust path 52. The steam sensor 53 sends, to a control unit 80 (shown in FIG. 5), a signal indicative of an amount of steam contained in the air or the like flowing through the second exhaust path 52.

In the case in which the air or the like in the heating chamber 2 is forcibly discharged to the outside of the body casing 1, the exhaust damper 49 and the air supply damper 51 are rotated to positions shown in one-dotted chain lines by a motor 60 for the exhaust damper (“exhaust damper motor 60” below) and a motor 61 for the air supply damper (“air supply damper motor 61” below) (shown in FIG. 5), respectively. In other words, the exhaust damper 49 and the air supply damper 51 are opened. Then, the exhaust fan 47 and the air supply fan 54 are driven by a motor 57 for the exhaust fan (referred to as “exhaust fan motor 57” below) and a motor 58 for the air supply fan (referred to as “air supply fan motor 58” below) (shown in FIG. 5). Consequently, the air or the like in the heating chamber 2 is drawn out of the forcible exhaust ports 48 and the natural exhaust port 45 to the outside of the heating chamber 2.

For cooling the magnetron 4 (shown in FIG. 5) or the like between the body casing 1 and the heating chamber 2, the air supply fan 54 is driven in a state in which the air supply damper 51 is closed. Consequently, the air blown out of the air supply fan 54 through the air supply path 55 cools electrical components such as the magnetron 4 disposed in a space between the body casing 1 and the heating chamber 2.

FIG. 5 is a control block diagram showing the thermal cooking apparatus.

The thermal cooking apparatus includes a control unit 80 configured from a microcomputer and an input/output circuit. The upper heater 20, the middle heater 21, the lower heater 22, the steam generating heater 103, the circulation fan motor 56, the exhaust fan motor 57, the air supply fan motor 58, the circulation damper motor 59, the exhaust damper motor 60, the air supply damper motor 61, the operation panel 9, the steam sensor 53, an inside temperature sensor 70, a steam generating temperature sensor 140, the water level sensor 105, the tube pump 25, the magnetron 4 and the like are connected to the control unit 80. The control unit 80 controls the upper heater 20, the middle heater 21, the lower heater 22, the steam generating heater 103, the circulation fan motor 56, the exhaust fan motor 57, the air supply fan motor 58, the circulation damper motor 59, the exhaust damper motor 60, the air supply damper motor 61, the tube pump 25, the magnetron 4 or the like based on a signal sent from the operation panel 9, the steam sensor 53, the inside temperature sensor 70, the steam generating temperature sensor 140, the water level sensor 105 or the like.

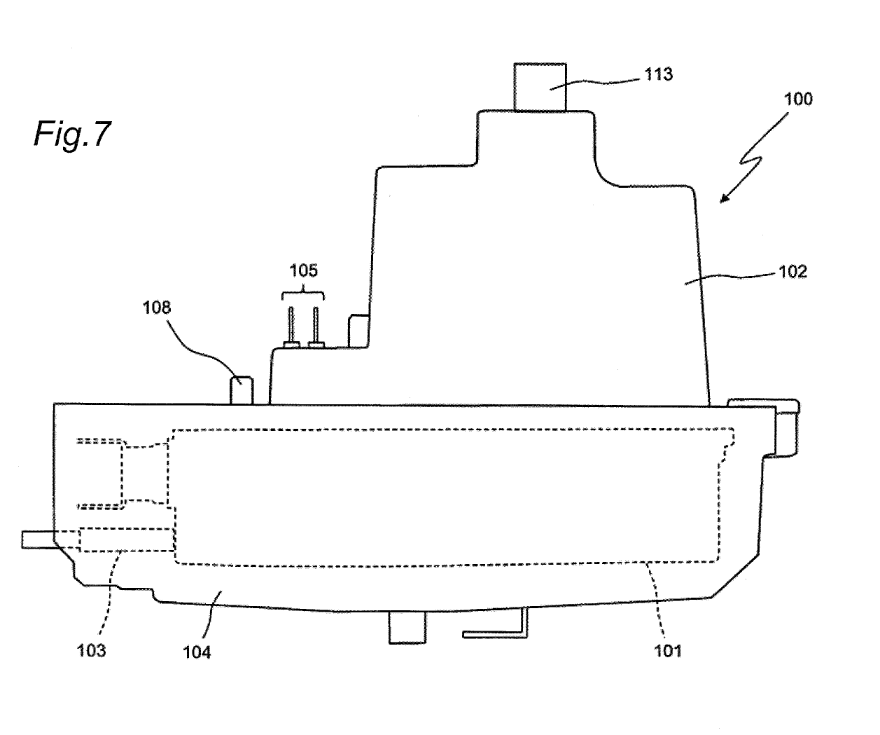

FIG. 6 is a top view showing the steam generating device 100 and FIG. 7 is a side view showing the steam generating device 100. In FIGS. 6 and 7, 105 denotes the water level sensor, 108 denotes a connecting portion for water supply and discharge ports, and 113 denotes a connecting portion for a steam outlet.

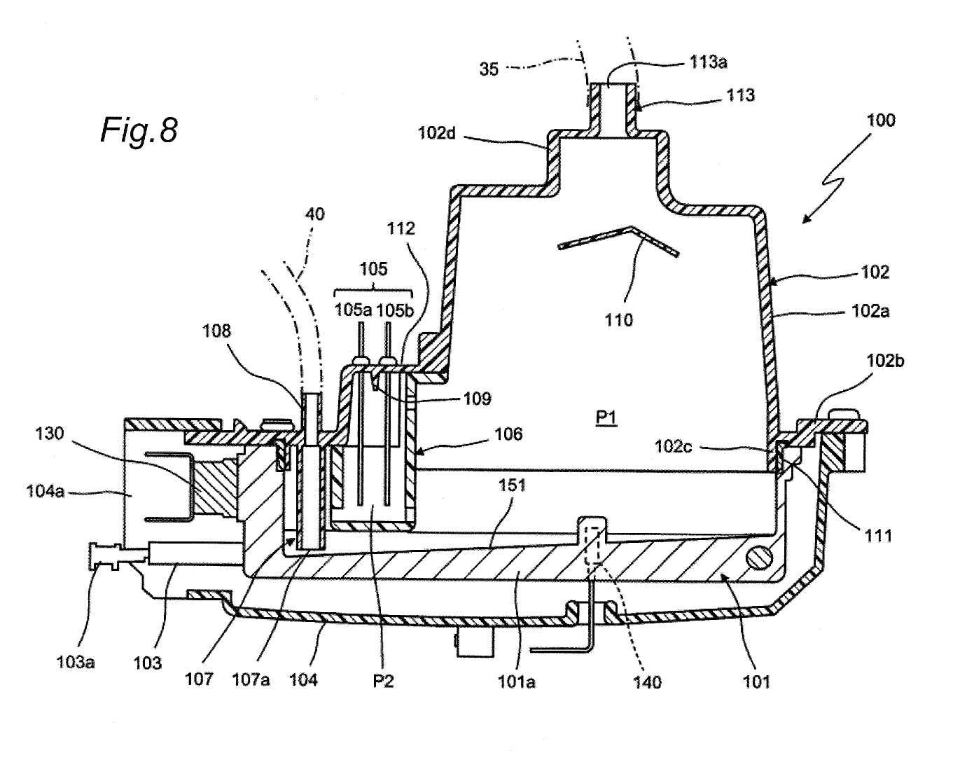

As shown in FIGS. 6 and 7, the steam generating device 100 includes the steam generating container 101 taking a rectangular shape seen on a plane, the lid portion 102 constituted by a heat resistant resin which covers the upper opening of the steam generating container 101 and forms a steam generating space P1 (shown in FIG. 8) together with the steam generating container 101, the steam generating heater 103 embedded in the steam generating container 101, and a heat insulating cover 104 formed at a distance from the steam generating container 101 to cover the steam generating container 101. The heat insulating cover 104 is formed of a heat resistant resin such as a PPS (polyphenylene sulfide) resin and is fixed to a flange portion 102b of the lid portion 102. The steam generating container 101 is formed of a metal (an aluminum alloy or the like) having the steam generating heater 103 cast therein. The heat insulating cover 104 may be a resin which is not deformed by heat of approximately 100° C. in place of the heat resistant resin.

The lid portion 102 is formed of the heat resistant resin. When a large amount of steam is to be generated, consequently, the height of the lid portion 102 can easily be regulated so as to prevent the foamy boiling water having high viscosity which tends to be generated with the occurrence of the scale from entering the steam pipe 36, and furthermore, the thickness of the lid portion 102 itself can be reduced more greatly than that of a lid portion formed of ceramic or the like.

Bumping water or the like sticks to the internal wall of the lid portion 102. By using a heat resistant resin, however, the temperature of the lid portion 102 can be prevented from being raised greatly, evaporation of the water in the internal wall of the lid portion 102 can be suppressed and the adhesion of the scale to the internal wall of the lid portion 102 can be reduced.

Consequently, most of the scale adhesion can be caused to stay in the bottom portion 101a of the steam generating container 101, and the water remaining in the steam generating container 101 can easily be discharged to the outside of the steam generating container 101 together with waste water through the water supply/discharge tube 40 (shown in FIG. 3) after completion of cooking.

The heat insulating cover 104 formed at a distance from the steam generating container 101 in order to cover the steam generating container 101 is fixed to the lid portion 102 so that an air heat insulating layer is formed between the steam generating container 101 and the heat insulating cover 104. Heat conduction from the steam generating container 101 to the lid portion 102 formed of the heat resistant resin is also lessened. Thus, the steam generating container 101 is covered with the heat insulating cover 104 in a contact state with only the lid portion 102. Consequently, heat radiation of the steam generating container 101 can be suppressed so that a heating efficiency can be enhanced.

FIG. 8 is a sectional view seen from an XIII-XIII line in FIG. 6.

As shown in FIG. 8, the lid portion 102 has a body portion 102a, a flange portion 102b provided on a lower end of the body portion 102a, and an inserting portion 102c extended downward from a lower surface of the flange portion 102b. The body portion 102a, the flange portion 102b and the inserting portion 102c are formed integrally by a heat resistant resin

The inserting portion 102c of the lid portion 102 is inserted into an inner peripheral side of the upper opening of the steam generating container 101, and a portion between the inner peripheral side of the steam generating container 101 and the outer peripheral surface of the inserting portion 102c of the lid portion 102 is sealed with a circular seal member 111. The circular seal member 111 is formed of a heat resistant resin such as a silicone rubber. The inner peripheral surface of the steam generating container 101 is subjected to silicone coating.

A water level detecting chamber cover 106 is disposed in the steam generating space P1 formed by the steam generating container 101 and the lid portion 102. A water level detecting chamber P2 is formed by the water level detecting chamber cover 106 and the electrodes 105a and 105b of the water level sensor 105 are accommodated in the water level detecting chamber P2.

A partition wall 109 for dividing the electrodes 105a and 105b is erected on a lower surface of a step portion 112 of the lid portion 102. Scale or dew condensation water is prevented from being laid between the electrodes 105a and 105b by the partition wall 109 so that erroneous detection through the water level sensor 105 can be prevented.

Even if the electrodes 105a and 105b of the water level sensor 105 and the steam generating container 101 are of different types of metals, The inner peripheral surface of the steam generating container 101 is insulated and coated. Therefore, it is possible to prevent corrosion between different types of metals in the electrodes 105a and 105b and the steam generating container 101.

Even if the water level detecting chamber P2 is formed to surround the water level sensor 105 by the water level detecting chamber cover 106 provided in the steam generating space P1 so that the water in the steam generating container 101 boils and a water surface foams, the water level in the steam generating container 101 can be detected accurately by the water level sensor 105 because influence on the inside of the water level detecting chamber P2 is small and the water level is stabilized.

The water level detecting chamber P2 formed by the water level detecting chamber cover 106 is disposed on the connecting terminal 103a side as an example of a power supplying portion of the steam generating heater 103, that is, a region side having a low temperature in the steam generating container 101. Consequently, an amount of boiling bubbles generated under the water level detecting chamber P2 is reduced. Therefore, a water level in the steam generating container 101 can be detected more accurately by the water level sensor 105.

Thus, the water level in the steam generating container 101 can be controlled accurately by the water level sensor 105. Therefore, the boiling can be performed in a state in which a small amount of water is stored in the steam generating container 101.

The step portion 112 of the lid portion 102 is provided with a cylindrical connecting portion 108 for the water supply/discharge port (referred to as “water supply/discharge port connecting portion 108”) penetrating the step portion 112. Furthermore, there is provided a water supply/discharge pipe 107 extended downward in the steam generating container 101 from the water supply/discharge port connecting portion 108 in the step portion 112 of the lid portion 102 and communicating with the water supply/discharge port connecting portion 108. Through a water supply/discharge port 107a at a lower end of the water supply/discharge pipe 107, the water is supplied into the steam generating container 101 and is discharged from the inside of the steam generating container 101. The water supply/discharge port 107a is opened in the vicinity of the bottom portion 101a in the steam generating container 101. One of ends of the water supply/discharge tube 40 is connected to the water supply/discharge port connecting portion 108.

The water supply/discharge port 107a is an example of a water supply port and a water discharge port.

The water can be supplied and discharged through the water supply/discharge port 107a provided in the steam generating container 101, and the structure can be simplified more greatly than the structure in which the water supply port and the water discharge port are provided separately. Consequently, a size of the steam generating device 100 can be reduced.

A protrusion 102d is provided on an upper side of the body portion 102a in the lid portion 102. A top end of the protrusion 102d is provided with a steam outlet connecting portion 113 having a steam outlet 113a. One of ends of the steam tube 35 is connected to the steam outlet connecting portion 113.

Furthermore, the steam generating device 100 includes, within the lid portion 102 and at a lower side of the protrusion 102d, a boiling water shielding wall 110 for blocking boiling water coming from the steam generating container 101, which wall is located in a region opposed to the protrusion 102d and one of shoulder parts (on a right side of the protrusion 102d shown in FIG. 8) in the vicinity of the protrusion 102d of the lid portion 102. The boiling water shielding wall 110 is bent with its section taking a shape of a chevron or an inverted v.

The boiling water going upward from a corresponding region to the protrusion 102d in an evaporation surface in the steam generating container 101 is blocked and returned to a lower part by the boiling water shielding wall 110 provided within the lid portion 102 at the lower side of the protrusion 102d, and furthermore, the boiling water blown up from corresponding regions to both shoulder parts of the protrusion 102d of the evaporation surface in the steam generating container 101 is caused to collide with the both shoulder parts of the protrusion 102d and is returned to a lower part. Consequently, the boiling water generated in the steam generating container 101 can be inhibited from being blown out of the steam outlet 113a of the protrusion 102d provided on an upper side of the lid portion 102 and water droplets can be reliably prevented from being scattered into the heating chamber 2.

In FIG. 8, the steam generating heater 103 is a U-shaped heater and is embedded to be extended from one of sides in a longitudinal direction of the bottom portion 101a of the steam generating container 101 to the other side (see FIG. 6).

In the steam generating container 101 taking a shape of a slender rectangle seen on a plane, the steam generating heater 103 (a heat source) is embedded in the longitudinal direction of the bottom portion 101a. Consequently, it is possible to dispose the steam generating heater 103 to be a slender sheath heater over the whole inside of the steam generating container 101, resulting in an enhancement in a heating efficiency. A part of a bottom surface in the steam generating container 101 is inclined in the longitudinal direction in which the steam generating heater 103 embedded in the bottom portion 101a of the steam generating container 101 is extended. Thus, an inclined surface 151 for collecting the water into a water supply/discharge port 107a to be a water discharge port can easily be formed on the bottom portion 101a in the steam generating container 101 in water discharge and the water supply/discharge port 107a is provided in the lowest position of the inclined surface 151. Consequently, the water in the steam generating container 101 can be discharged reliably from the water supply/discharge port 107a.

A part of a bottom surface in the steam generating container 101 is inclined in such a manner that a bottom surface part disposed below the water supply/discharge port 107a to be a water supply port provided in the steam generating container 101 is lowered. By using the water supply/discharge port 107a as the water discharge port, therefore, it is possible to reliably discharge the water in the steam generating container 101 from the water supply/discharge port 107a.

Furthermore, the steam generating heater 103 is embedded in the bottom portion 101a of the steam generating container 101 in such a manner that the connecting terminal 103a (the power supplying portion) of the steam generating heater 103 taking a U shape to be the heat source is positioned on one of the water supply/discharge port 107a sides and the curved part of the steam generating heater 103 is positioned on the other of the steam outlet 113a sides (see FIG. 6). At the water supply/discharge port 107a side of the steam generating heater 103, consequently, a temperature on the connecting terminal 103a side of the steam generating heater 103, that is, the water supply/discharge port 107a side is lower and generation of bubbles through boiling is lessened as compared with the steam outlet 113a side of the steam generating heater 103. Therefore, the steam can be prevented from flowing out of the water supply/discharge port 107a in the generation of the steam.

A part of the bottom surface in the steam generating container 101 is inclined in such a manner that a region opposed to a portion in which the temperature of the steam generating heater 103 is low is lower than a region opposed to a portion in which the temperature of the steam generating heater 103 is high over the bottom surface in the steam generating container 101 (the inclined surface 151). By providing the water supply/discharge port 107a in the vicinity of the opposed region to the portion in which the temperature of the steam generating heater 103 is low over the bottom surface in the steam generating container 101, therefore, it is possible to cause evaporation of the water with difficulty and to suppress occurrence of scale even if the water is discharged from the water supply/discharge port 107a immediately after completion of the generation of the steam.

By discharging the water in the steam generating container 101 through the water supply/discharge tube 40 (the water supply path) of the water supply device (25, 26, 40, 43, 44), it is possible to supply the water to the inside of the steam generating container 101 and to discharge the water from the inside of the steam generating container 101. Thus, it is possible to simplify the structure without requiring separate provision of the water discharge path.

In the thermal cooking apparatus, furthermore, the water is supplied from the water supply device (25, 26, 40, 43, 44) to an opposed region (a lower side of the water supply/discharge port 107a) to the lowest part of the bottom surface in the steam generating container 101 through the water supply/discharge tube 40 (the water supply path) by the tube pump 25 for performing a water supplying operation. On the other hand, the water is discharged from the opposed region to the lowest part of the bottom surface in the steam generating container 101 through the water supply/discharge tube 40 by the tube pump 25 for performing a water discharging operation. Therefore, the residual water in the steam generating container 101 after the end of the steam generation can be discharged reliably. By simple control for switching the driving direction of the tube pump 25, consequently, it is possible to supply and discharge the water through the water supply/discharge tube 40.

In the first embodiment, the water is supplied and discharged in the opposed region to the lowest part of the bottom surface in the steam generating container 101 (the lower side of the water supply/discharge port 107a). However, the water may be supplied and discharged in the vicinity of the opposed region to the lowest part of the bottom surface in the steam generating container 101.

In the steam generating container 101 having a small capacity, an amount of residual water to be discharged or drained therefrom is lessened, so that a water discharging receiver having a large capacity (the water supply tank 26 in the present embodiment) or a pump having a high flow rate is not required. The steam generating heater 103 is controlled to evaporate the water in the steam generating container 101 so as to reduce the amount of the water and hence the amount of water to be discharged. Thus, during discharge of water, heat is radiated from discharged water in the middle of the water discharging path (the water supply/discharge tube 40 in the present embodiment) and the temperature of the discharged water is reduced. Therefore, the water can be discharged even immediately after the end of the steam generation.

In the thermal cooking apparatus, the water supply/discharge port 107a is opened downward from the lower end of the water supply/discharge pipe 107. As compared with the case in which the water supply/discharge port is provided in the bottom portion 101a of the steam generating container 101, therefore, the water supply/discharge port 107a can be prevented from being blocked with a foreign substance.

The heat insulating cover 104 has an opening portion 104a formed to be opened toward a downstream side of cooling air fed from the air supply fan 54 (shown in FIG. 4) (see FIG. 4). The opening portion 104a serves to lead, to an outside, the connecting terminal 103a according to an example of the power supplying portion of the steam generating heater 103 cast into the steam generating container 101.

The connecting terminal 103a of the steam generating heater 103 is led from the opening portion 104a of the heat insulating cover 104 to the outside through a wiring or the like. The opening portion 104a of the heat insulating cover 104 is formed to be opened toward the downstream side of the cooling air fed from the air supply fan 54 for cooling the electrical component. Consequently, the cooling air fed from the cooling fan 54 does not enter the opening portion 104a of the heat insulating cover 104. Therefore, it is possible to prevent the temperature of the steam generating container 101 from being lowered by the cooling air.

Furthermore, a temperature fuse 130 is attached to a side surface of the steam generating container 101 in the vicinity of the connecting terminal 103a of the steam generating heater 103. The temperature fuse 130 interrupts a voltage to be applied to the connecting terminal 103a of the steam generating heater 103 when the steam generating container 101 reaches an abnormal temperature.

A steam generating temperature sensor 140 is attached to a central part of the bottom portion 101a of the steam generating container 101.

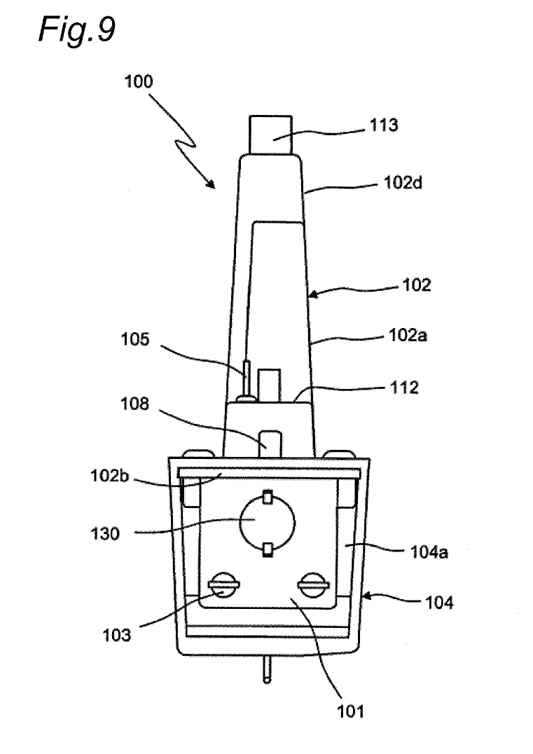

FIG. 9 is a side view showing the steam generating device 100 illustrated in FIG. 7 as seen from a left-hand side, and the same components as those in FIGS. 7 and 8 have the same reference numerals.

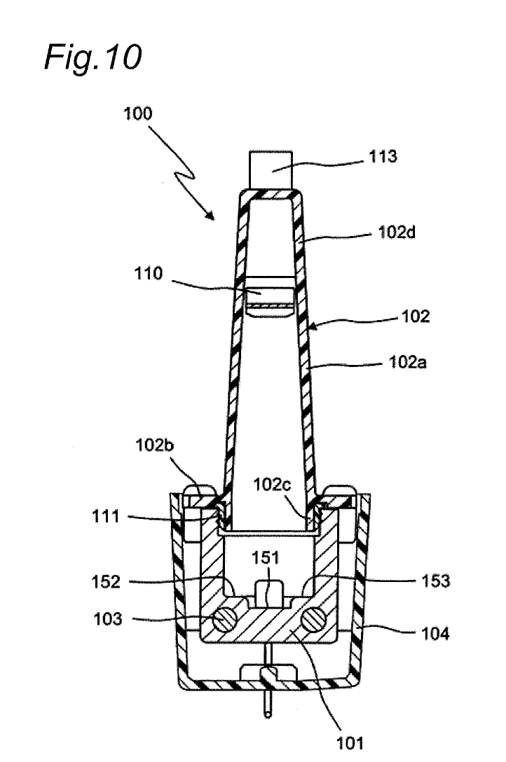

FIG. 10 is a sectional view seen in an X-X line of FIG. 6, and the same components as those in FIGS. 7 and 8 have the same reference numerals. As shown in FIG. 10, the bottom surface in the steam generating container 101 is configured from the inclined surface 151 formed to be inclined in a direction in which the steam generating heater 103 is extended and flat surfaces 152 and 153 formed on both sides of the inclined surface 151. The flat surfaces 152 and 153 are provided to cast the steam generating heater 103 into the steam generating container 101. It is also possible to increase the width of the steam generating container 101, thereby eliminating the flat surface to set the bottom surface in the steam generating container 101 to be only the inclined surface.

By providing dents and protrusions in the steam generating container 101 to increase a heat transfer surface area, it is possible to enhance a steam generation efficiency.

The water is supplied through the water supply/discharge port 107a to the opposed region to the lowest part of the inclined surface 151 in the steam generating container 101. On the other hand, the water is discharged from the opposed region to the lowest part of the bottom surface in the steam generating container 101 through the water supply/discharge port 107a (shown in FIG. 8).

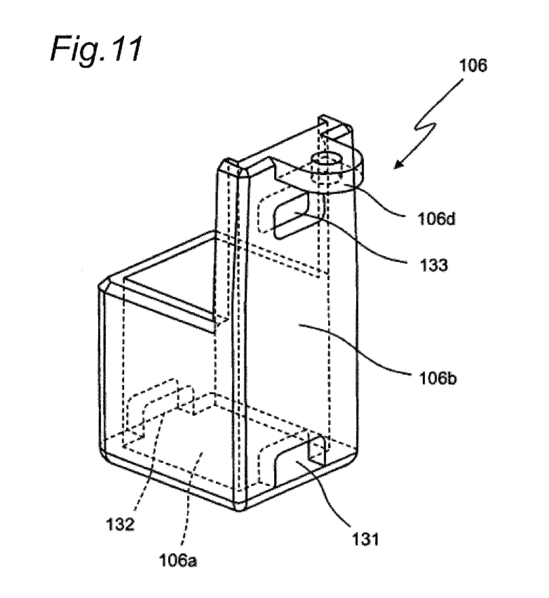

FIG. 11 is a perspective view showing the water level detecting chamber cover 106 in the steam generating device 100 illustrated in FIG. 8. As shown in FIG. 11, the water level detecting chamber cover 106 includes a rectangular bottom portion 106a covering a whole lower part, and a side wall 106b erected from four sides (outer edges) of the bottom portion 106a and provided with through holes 131 and 132 in the vicinity of the bottom portion 106a. The through holes 131 and 132 are water intrusion holes and take rectangular shapes having a length of approximately 4 mm and a width of approximately 8 mm. One of four side walls 106b is extended upward from the other walls and is provided with an attaching portion 106d protruded from an upper end to a side part. A through hole 133 is provided in the vicinity of the attaching portion 106d of the side wall 106b at a lower side thereof.

Although the water level detecting chamber cover 106 is provided separately from the lid portion 102 in the first embodiment, the cover for a water level detecting chamber and the lid portion may be formed integrally by resin molding.

Herein, the electrodes 105a and 105b are disposed in such a manner that lower ends of the electrodes 105a and 105b are provided above the through holes 131 and 132 of the water level detecting chamber cover 106.

The water level detecting chamber cover 106 has a whole lower part covered with the bottom portion 106a. Therefore, the boiling bubble generated on the surface of the bottom portion 101a of the steam generating container 101 in the lower part does not enter the water level detecting chamber P2. In the side wall 106b erected from the outer edge of the bottom portion 106a of the water level detecting chamber cover 106, the through holes 131 and 132 are provided in the vicinity of the bottom portion 106a. Consequently, the water can come/go from/to the inside and outside of the water level detecting chamber P2. Thus, a water level in the water level detecting chamber P2 can be maintained equivalently to a water level in the steam generating container 101 and stably with a simple structure.

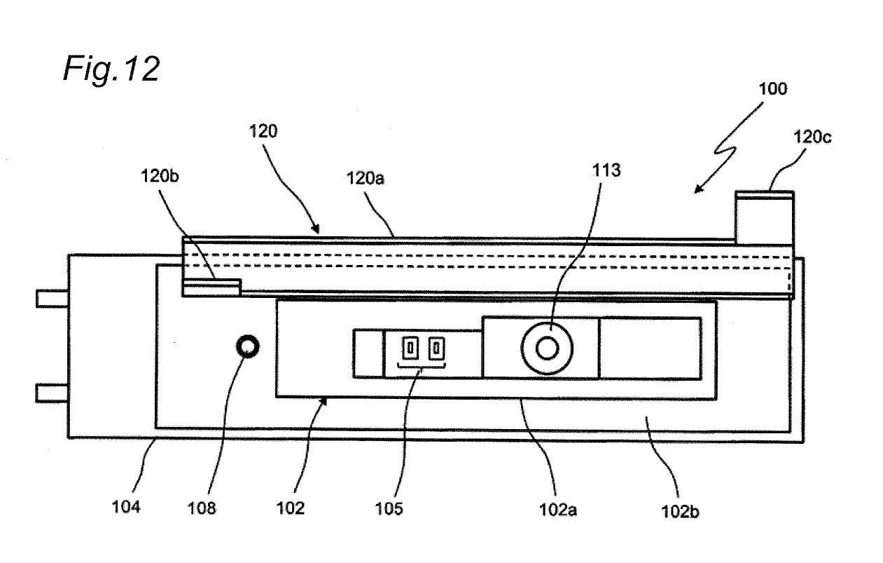

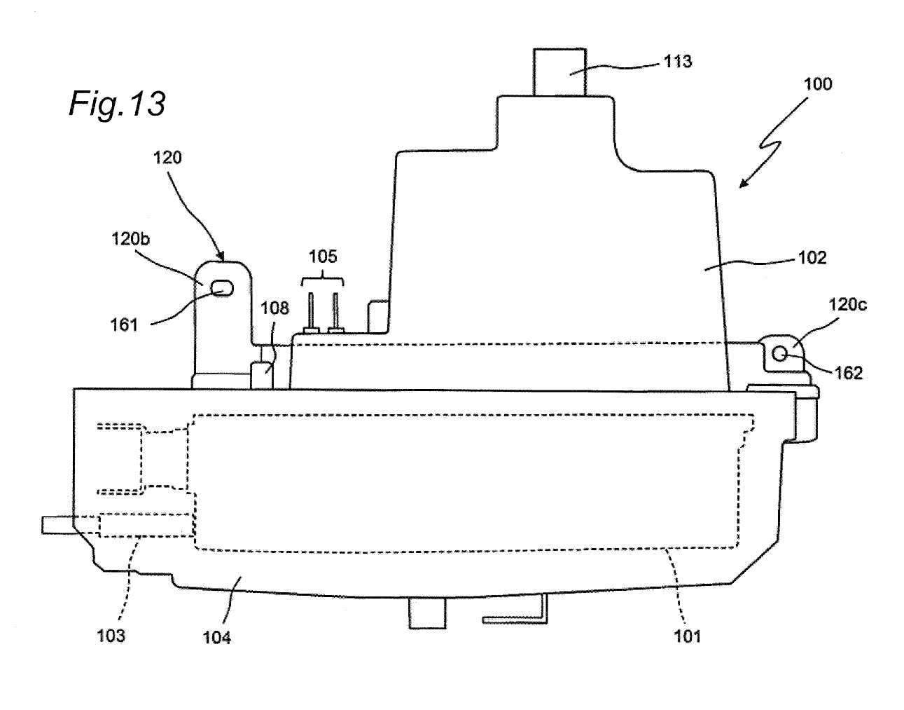

FIG. 12 is a top view showing the steam generating device 100 using an attaching member 120 and FIG. 13 is a side view showing the steam generating device 100 using the attaching member 120. In FIGS. 12 and 13, the same components as those in FIGS. 6 and 7 have the same reference numerals.

As shown in FIGS. 12 and 13, the steam generating device 100 includes the attaching member 120 for attaching the steam generating container 101 to a back face side of the heating chamber 2 (shown in FIGS. 1 and 2) through the lid portion 102. The attaching member 120 has a base portion 120a taking a rectangular shape, a fixing portion 120b provided on one of ends of the base portion 120a, and a fixing portion 120c provided on the other end of the base portion 120a. The base portion 120a of the attaching member 120 is fixed to the flange portion 102b of the lid portion 102 with a screw (not shown). Screws (not shown) inserted through holes 161 and 162 provided on the fixing portions 120b and 120c of the attaching member 120 respectively are fastened into screw holes (not shown) at the heating chamber 2 side to attach the steam generating container 101 to the back face of the heating chamber 2 through the attaching member 120.

The steam generating container 101 is attached to the heating chamber 2 through the lid portion 102 by the attaching member 120. Therefore, the steam generating container 101 can suppress heat radiation from the steam generating container 101 to the heating chamber 2, thereby enhancing a heating efficiency without directly coming in contact with the heating chamber 2.

Although the steam generating container 101 is attached to the heating chamber 2 by the attaching member 120 through the lid portion 102 in the first embodiment, the steam generating container 101 may be attached to an attached member provided on the side of the heating chamber 2 in the body casing 1 through the lid portion 102 by the attaching member 120.

According to the steam generating device 100 in accordance with the first embodiment, the upper opening of the steam generating container 101 formed of a metal having the steam generating heater 103 (the heat source) cast therein is covered with the lid portion 102 made of a heat resistant resin, and the steam generating space P1 is formed by the steam generating container 101 and the lid portion 102. Even if the water in the steam generating container 101 heated by the steam generating heater 103 is boiled and evaporated so that the inside of the steam generating space P1 is filled with steam or boiling bubbles, consequently, the lid portion 102 made of a heat resistant resin does not reach such a high temperature as to evaporate water droplets. For this reason, scale is not generated on the internal wall surface of the lid portion 102. Consequently, it is possible to suppress the generation of the scale and a reduction in the heating efficiency, thereby preventing the water droplets and/or the scale from being scattered into the heating chamber 2. Accordingly, it is possible to perform excellent heat cooking using steam.

Referring to a conventional steam generating device using a container having a heat source cast therein, a steam generating container and a lid portion are formed of metals. If an output of a heat source is increased, particularly, a size of a whole container is increased due to a countermeasure against no-water burning or a countermeasure against bumping, a heat capacity is increased so that a rise time of steam generation is large, or an amount of heat radiation from a large container itself is increased, resulting in a reduction in the heating efficiency.

On the other hand, in the steam generating device 100 according to the first embodiment, the size of the steam generating container 101 is reduced and a heat capacity is decreased such that a necessary amount of steam can be obtained, and furthermore, there is employed a structure in which a heat radiation loss from the steam generating container 101 to the outside is small. Consequently, a heat transfer efficiency to the water in the steam generating container 101 can be enhanced, the rise time of the steam generation can be decreased and the heating efficiency can be improved. By enhancing the heat transfer efficiency to the water in the steam generating container 101, it is also possible to enhance a temperature controllability of the steam generating heater 103 (the heat source) through the control unit 80.

Although the lid portion 102 is made of a heat resistant resin in the first embodiment, a portion between the steam generating container and the lid portion may be heat insulated by a heat insulating member.

By using the steam generating device 100 in a thermal cooking apparatus, it is possible to enhance performance of the thermal cooking apparatus.

Although the boiling water shielding wall 110 for blocking the boiling water from the steam generating container 101 is provided within the lid portion 102 in the first embodiment, the boiling water shielding wall may be dispensed with. However, the boiling water shielding wall may be preferably provided within the lid portion in order to reliably prevent the boiling water generated in the steam generating container 101 from being scattered into the heating chamber 2.

### Second Embodiment

A thermal cooking apparatus according to a second embodiment of the present invention has the same structure as that of the thermal cooking apparatus according to the first embodiment except for a heat source of a steam generating device.

In the thermal cooking apparatus according to the second embodiment, a steam generating heater serving as a heat source is embedded in a bottom portion of a steam generating container in combination of two linear heaters in place of a U-shaped heater.

According to the steam generating device of the thermal cooking apparatus having the structure described above, the linear heaters are embedded in the bottom portion of the steam generating container in combination. Consequently, the steam generating container can easily be cast so that a cost can be reduced.

### Third Embodiment

A thermal cooking apparatus according to a third embodiment of the present invention has the same structure as that of the thermal cooking apparatus according to the first embodiment except for a steam generating device.

In the thermal cooking apparatus according to the first embodiment, there is used the steam generating device 100 including the steam generating container 101 taking the shape of a rectangular parallelepiped in which the U-shaped steam generating heater is embedded in the longitudinal direction. A steam generating container of the steam generating device according to the third embodiment is not a container of a rectangular parallelepiped taking a rectangular shape seen on a plane but a cylindrical container taking a circular shape seen on the plane. A heat source is embedded in a bottom portion of the cylindrical steam generating container by casting.

### Fourth Embodiment

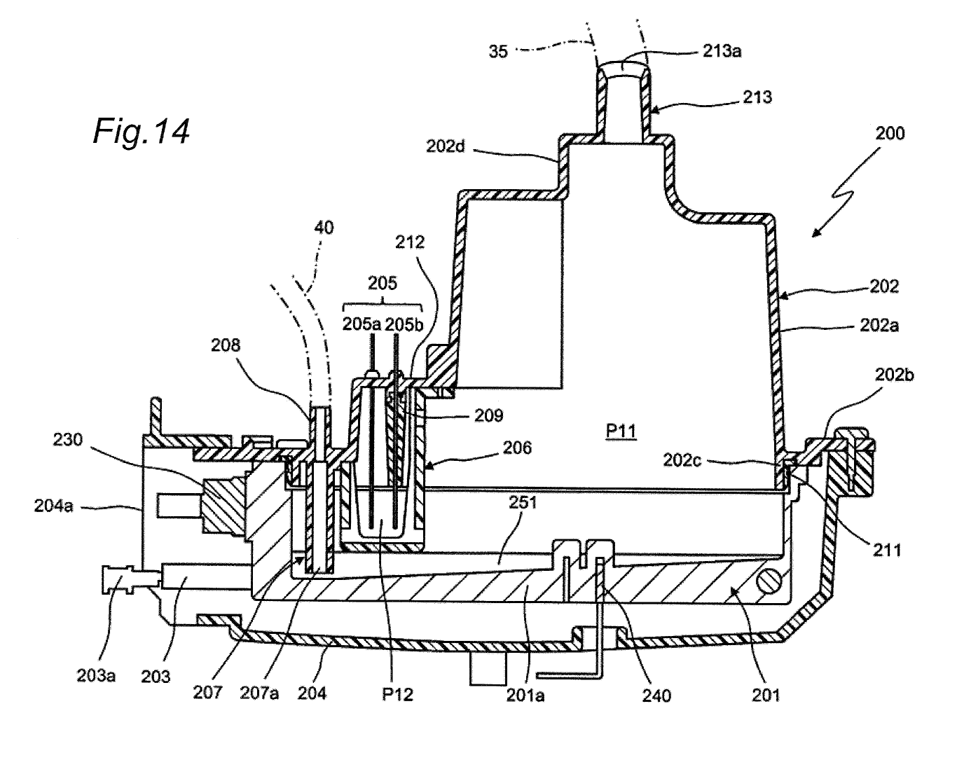

FIG. 14 is a sectional view showing a steam generating device 200 according to a fourth embodiment of the present invention. The steam generating device 200 according to the fourth embodiment is used in a thermal cooking apparatus having the same structure as that of the thermal cooking apparatus according to the first embodiment except for a steam generating device 100.

As shown in FIG. 14, a lid portion 202 has a body portion 202a, a flange portion 202b provided on a lower end of the body portion 202a, and an inserting portion 202c extended downward from a lower surface of the flange portion 202b. The body portion 202a, the flange portion 202b and the inserting portion 202c are formed integrally by a heat resistant resin.

The inserting portion 202c of the lid portion 202 is inserted into an inner peripheral side of the upper opening of the steam generating container 201, and a portion between the inner peripheral side of the steam generating container 201 and the outer peripheral surface of the inserting portion 202c of the lid portion 202 is sealed with a circular seal member 211. The circular seal member 211 is formed by a heat resistant resin such as a silicone rubber. The inner peripheral surface of the steam generating container 201 is subjected to silicone coating.

A cover 206 for a water level detecting chamber is disposed in a steam generating space P11 formed by the steam generating container 201 and the lid portion 202. A water level detecting chamber P12 is formed by the cover 206 for a water level detecting chamber and electrodes 205a and 205b of a water level sensor 205 are accommodated in the water level detecting chamber P12.

There is provided an electrode cover portion 209 for covering a portion excluding a lower end side of the electrode 205b. By the electrode cover portion 209, scale or dew condensation water is prevented from being laid between the electrodes 205a and 205b so that erroneous detection through the water level sensor 205 can be prevented.

Even if the electrodes 205a and 205b of the water level sensor 205 and the steam generating container 201 are of different types of metals, the inner peripheral surface of the steam generating container 201 is insulated and coated.

The water level detecting chamber P12 is formed to surround the water level sensor 205 by the cover 206 for a water level detecting chamber provided in the steam generating space P11.

The water level detecting chamber P12 formed by the cover 206 for a water level detecting chamber is disposed on a connecting terminal 203a side as an example of a power supplying portion of a steam generating heater 203, that is, a region side having a low temperature in the steam generating container 201.

A step portion 212 of the lid portion 202 is provided with a cylindrical connecting portion 208 for a water supply/discharge port penetrating the step portion 212. Furthermore, there is provided a water supply/discharge pipe 207 extended downward in the steam generating container 201 from the connecting portion 208 for a water supply/discharge port in the step portion 212 of the lid portion 202 and communicating with the connecting portion 208 for a water supply/discharge port. Through a water supply/discharge port 207a at a lower end of the water supply/discharge pipe 207, the water is supplied into the steam generating container 201 and is discharged from the inside of the steam generating container 201. The water supply/discharge port 207a is opened in the vicinity of a bottom portion 201a in the steam generating container 201. One of ends of the water supply/discharge tube 40 is connected to the connecting portion 208 for a water supply/discharge port.

The water supply/discharge port 207a is an example of a water supply port and a water discharge port.

A protrusion 202d is provided on an upper side of a body portion 202a in the lid portion 202. A tip of the protrusion 202d is provided with a connecting portion 213 for a steam outlet having a steam outlet 213a. One of ends of a steam tube 35 is connected to the connecting portion 213 for a steam outlet.

In FIG. 14, the steam generating heater 203 is a U-shaped heater and is embedded to be extended from one of sides in a longitudinal direction of the bottom portion 201a of the steam generating container 201 to the other side.

A part of a bottom surface in the steam generating container 201 is inclined in such a manner that a bottom surface part disposed below the water supply/discharge port 207a to be a water supply port provided in the steam generating container 201 is lowered.

Furthermore, the steam generating heater 203 is embedded in the bottom portion 201a of the steam generating container 201 in such a manner that the connecting terminal 203a (the power supplying portion) of the steam generating heater 203 taking a U shape to be the heat source is positioned on one of the water supply/discharge port 207a sides and the curved part of the steam generating heater 203 is positioned on the other of the steam outlet 213a sides.

A part of the bottom surface in the steam generating container 201 is inclined in such a manner that a region opposed to a portion in which the temperature of the steam generating heater 203 is low is lower than a region opposed to a portion in which the temperature of the steam generating heater 203 is high over the bottom surface in the steam generating container 201 (an inclined surface 251).

In addition, the heat insulating cover 204 has an opening portion 204a formed to be opened toward a downstream side of cooling air fed from the air supply fan 54 (shown in FIG. 4) (see FIG. 4). The opening portion 204a serves to lead, to the outside, the connecting terminal 203a of the steam generating heater 203 cast into the steam generating container 201.

The connecting terminal 203a of the steam generating heater 203 is led from the opening portion 204a of the heat insulating cover 204 to the outside through a wiring or the like. The opening portion 204a of the heat insulating cover 204 is formed to be opened toward the downstream side of the cooling air fed from the air supply fan 54 for cooling an electrical component.

Furthermore, a temperature fuse 230 is attached to a side surface of the steam generating container 201 in the vicinity of the connecting terminal 203a of the steam generating heater 203.

A steam generating temperature sensor 240 is attached to a central part of the bottom portion 201a of the steam generating container 201.

In the same manner as the steam generating device 100 according to the first embodiment, the steam generating device 200 includes the attaching member 120 (shown in FIGS. 12 and 13) for attaching the steam generating container 201 to a back face side of the heating chamber 2 (shown in FIGS. 1 and 2) through the lid portion 202. The steam generating container 201 of the steam generating device 200 is attached to the back face of the heating chamber 2 through the attaching member 120.

The steam generating container 201 of the steam generating device 200 is attached to the heating chamber 2 through the lid portion 202 by the attaching member 120. Therefore, the steam generating container 201 can suppress heat radiation from the steam generating container 201 to the heating chamber 2, thereby enhancing a heating efficiency without directly coming in contact with the heating chamber 2.

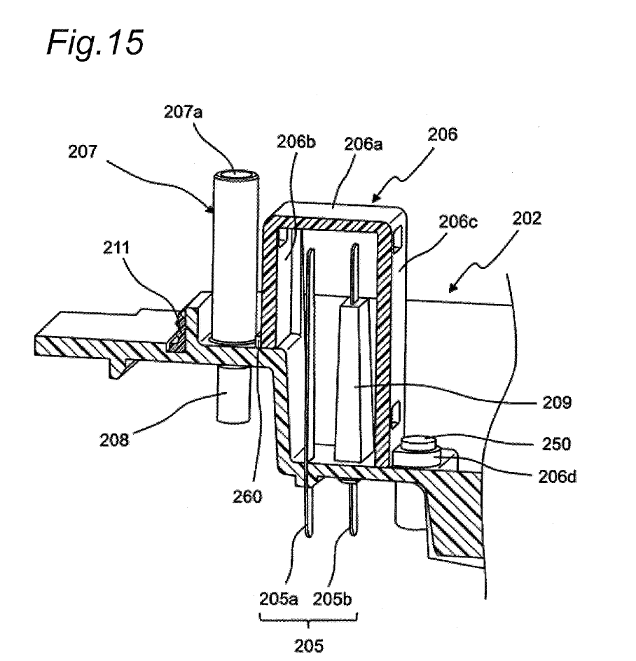

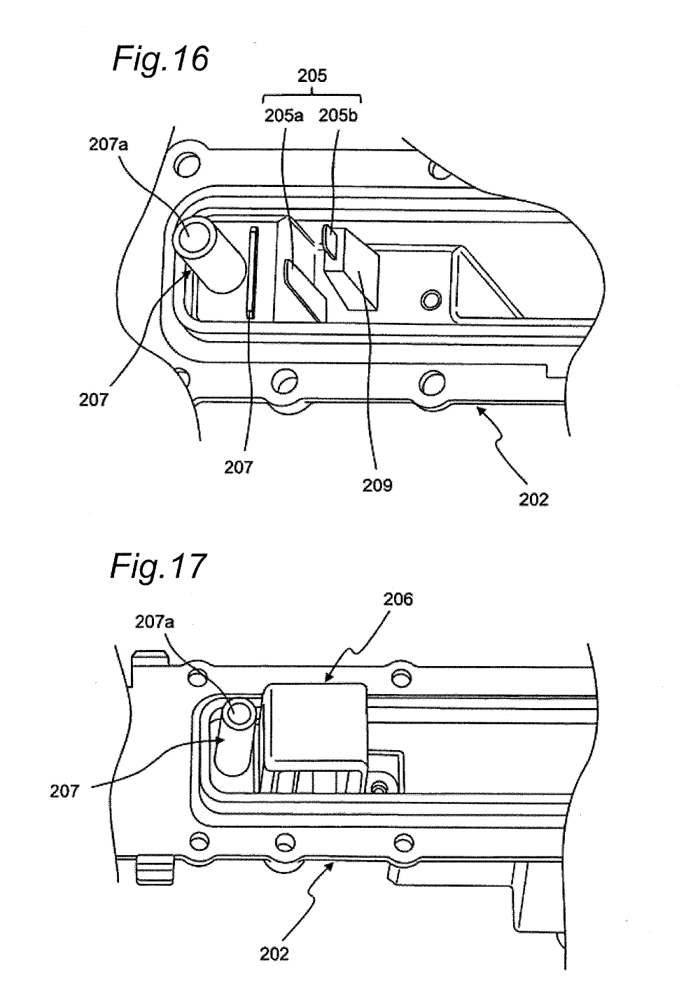

FIG. 15 is a sectional view showing a main part of the steam generating device 200, FIG. 16 shows a state in which the cover 206 for a water level detecting chamber in the main part is removed and FIG. 17 shows a state in which the cover 206 for a water level detecting chamber in the main part is attached. In FIGS. 15 to 17, the same components as those in FIG. 14 have the same reference numerals. In FIG. 15, upward and downward directions are reversed.

Referring to the steam generating device 200 according to the fourth embodiment, the electrode cover portion 209 for covering a part of the electrode 205b is provided in place of the partition wall 109 (shown in FIG. 8) in the first embodiment and the shape of the cover 206 for a water level detecting chamber is different from that in the first embodiment as shown in FIGS. 15 to 17.

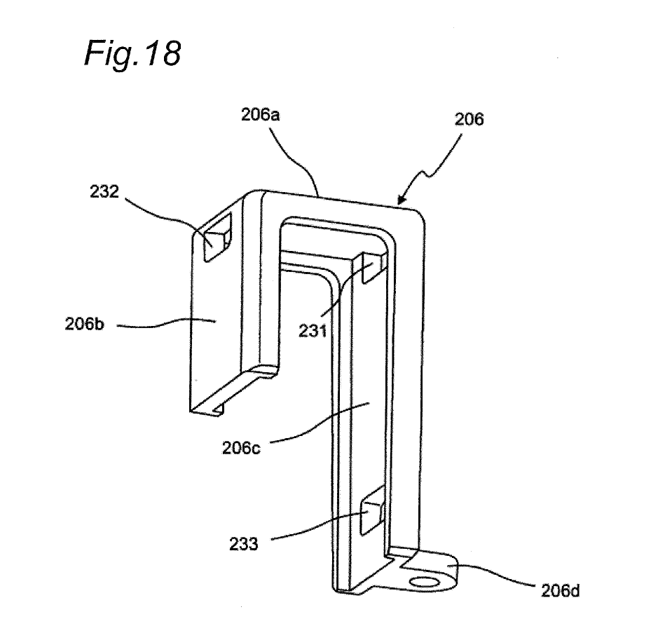

FIG. 18 is a perspective view showing the cover 206 for a water level detecting chamber. In FIG. 15, upward and downward directions are reversed.

As shown in FIG. 18, the cover 206 for a water level detecting chamber includes a rectangular bottom portion 206a covering a whole lower part, and side walls 206b and 206c erected from two opposed sides of the bottom portion 206a and provided with through holes 231 and 232 in the vicinity of the bottom portion 206a. The through holes 231 and 232 are water intrusion holes and take rectangular shapes having a length of approximately 4 mm and a width of approximately 8 mm. The side wall 206c is extended upward from the side wall 206b and is provided with an attaching portion 206d protruded from an upper end to a side part. A through hole 233 is provided in the vicinity of the attaching portion 206d of the side wall 206b at a lower side thereof.

As shown in FIG. 15, the cover 206 for a water level detecting chamber is attached to the lid portion 202 in such a manner that the upper end of the side wall 206b abuts on a rib 260 provided in the vicinity of the water supply/discharge pipe 207 of the lid portion 202. At this time, a screw 250 inserted through a hole provided on the attaching portion 206d is fastened to a screw hole (not shown) at the lid portion 202 side so that the cover 206 for a water level detecting chamber is thus attached to the lid portion 202.

The cover 206 for a water level detecting chamber has a whole lower part covered with the bottom portion 206a. Therefore, the boiling bubble generated on the surface of the bottom portion 201a of the steam generating container 201 shown in FIG. 8 does not enter the water level detecting chamber P12. In the side walls 206b and 206c erected from the outer edge of the bottom portion 206a of the cover 206 for a water level detecting chamber, the through holes 231 and 232 are provided in the vicinity of the bottom portion 206a and two other opposed sides of the bottom portion 206a without the side walls 206b and 206c provided are empty. Therefore, the water can come/go from/to the inside and outside of the water level detecting chamber P12. Thus, a water level in the water level detecting chamber P12 can be maintained equivalently to a water level in the steam generating container 201 and stably with a simple structure.

The steam generating device 200 according to the fourth embodiment and a thermal cooking apparatus using the steam generating device 200 have the same effects as those in the steam generating device and the thermal cooking apparatus according to the first embodiment.

In the steam generating device according to the present invention, the shape of the steam generating container is not limited to the shapes in the first to fourth embodiments but is preferably set properly depending on the structures of the body casing, the heating chamber or the like in the thermal cooking apparatus.

Although the thermal cooking apparatus using the steam generating device has been described in the first to fourth embodiments, the steam generating device according to the present invention may be utilized for other devices using steam.

In the thermal cooking apparatus according to the present invention, it is possible to perform healthy cooking by using overheated steam or saturated steam in a microwave oven or the like. For example, in the thermal cooking apparatus according to the present invention, overheated steam or saturated steam having a temperature of 100° C. or more is supplied to a surface of a food and the overheated steam or saturated steam adhering to the surface of the food condenses to give latent heat of condensation to the food. Therefore, the heat can be efficiently transferred to the food. Condensed water adheres to the surface of the food and a salt content and/or an oil content drops together with the condensed water. Consequently, it is possible to reduce the salt content or the oil content in the food. Furthermore, the inside of the heating chamber is filled with the overheated steam or the saturated steam and is thus brought into a hypoxic state. Consequently, it is possible to perform cooking suppressing oxidization of the food. Herein, the “hypoxic state” indicates a state in which a volume % of oxygen is equal to or lower than 10% (for example, 0.5 to 3%) in the heating chamber.

Although the specific embodiments of the present invention have been described, the present invention is not limited to the first to fourth embodiments and these embodiments can be variously changed or modified within the scope of the present invention.

The present invention and embodiments will be summarized in the following manner.

A steam generating device 100, 200 according to an aspect of the present invention includes:

a heat source 103, 203;

a steam generating container 101, 201 made of a metal having the heat source 103, 203 cast therein; and

a lid portion 102, 202 covering an upper opening of the steam generating container 101, 201 and forming a steam generating space P1 together with the steam generating container 101, 201,

the lid portion 102, 202 being made of a heat resistant resin or a portion between the steam generating container 101, 201 and the lid portion 102, 202 being heat insulated by a heat insulating member.

According to the above structure, the upper opening of the steam generating container 101, 201 formed of the metal having the heat source 103, 203 cast therein is covered with the lid portion 102, 202 and the steam generating space P1 is formed by the steam generating container 101, 201 and the lid portion 102, 202 and the lid portion 102, 202 is made of a heat resistant resin or the portion between the steam generating container 101, 201 and the lid portion 102, 202 is heat insulated by the heat insulating member. Consequently, water in the heat generating container 101, 201 heated by the heat source 103, 203 is boiled and evaporated. Even if the inside of the steam generating space P1 is filled with steam or boiling bubbles, the internal wall surface of the lid portion 102, 202 does not reach such a high temperature as to evaporate water droplets. Therefore, it is possible to suppress scale generated on the internal wall surface of the lid portion 102, 202. Consequently, it is possible to suppress the generation of the scale and a reduction in the heating efficiency, as well as preventing the water droplets and/or the scale from being scattered together with the steam.

In the steam generating device 100 according to an embodiment, the lid portion 102 has a protrusion 102d provided on an upper side thereof and a steam outlet 113a provided at an end of the protrusion 102d, and the steam generating device further includes, within the lid portion 102 and at a lower side of the protrusion 102d, a boiling water shielding wall 110 provided in a region opposed to both the protrusion 102d and a shoulder portion in the vicinity of the protrusion 102d and serving to block boiling water from the steam generating container 101.

Herein, the shoulder portion in the vicinity of the protrusion 102d may include both shoulder portions in the vicinity of the protrusion 102d or may be one of the shoulder portions in the vicinity of the protrusion 102d.

According to the embodiment, in the lid portion 102 at the lower side of the protrusion 102d, the boiling water shielding wall 110 provided in the region opposed to the protrusion 102d and the shoulder portion in the vicinity of the protrusion 102d blocks the boiling water going upward from a region corresponding to the protrusion 102d of the evaporation surface in the steam generating container 101 and makes the boiling water return to a lower part. Also, the boiling water directed upward from a region of the evaporation surface corresponding to both shoulder portions of the protrusion 102d in the steam generating container 101 collides with the both shoulder portions of the protrusion 102d and is returned to a lower part. Consequently, the boiling water generated in the steam generating container 101 can be prevented from being blown out of the steam outlet 113a of the protrusion 102d provided on the upper side of the lid portion 102. Consequently, water droplets can be reliably prevented from being blown out together with the steam.

Furthermore, a steam generating device 100, 200 according to an embodiment further includes a water level sensor 105 arranged to detect a water level in the steam generating container 101, 201; and a water level detecting chamber cover 106, 206 provided in the steam generating space P1 and forming a water level detecting chamber P2, P12 to surround the water level sensor 105.

According to the embodiment, the water level detecting chamber P2, P12 surrounding the water level sensor 105 is formed by the water level detecting chamber cover 106, 206 provided in the steam generating space P1, P11. Even if the water in the steam generating container 101, 201 is boiled so that a water surface is bubbled, consequently, the influence on the water level detecting chamber P2, P12 is small and the water level is stabilized. Therefore, it is possible to accurately detect the water level in the steam generating container 101, 201 by the water level sensor 105.

In a steam generating device 100, 200 according to an embodiment, the water level detecting chamber cover 106, 206 has a bottom portion 106a, 206a covering a whole lower part, and a side wall 106b, 206b, 206c erected from an outer edge of the bottom portion 106a, 206a and provided with a through hole 131, 132, 231, 232 in the vicinity of at least the bottom portion 106a, 206a.

According to the embodiment, the whole lower part is covered with the bottom portion 106a, 206a of the water level detecting chamber cover 106, 206. Therefore, the boiling bubble generated on the surface of the bottom portion 101a, 201a of the steam generating container 101, 201 in the lower part does not enter the inside of the water level detecting chamber P2, P12. The through hole 131, 132, 231, 232 is provided, in the vicinity of the bottom portion 106a, 206a, in the side wall 106b, 206b, 206c erected from the outer edge of the bottom portion 106a, 206a of the water level detecting chamber cover 106, 206. Consequently, the water can come/go from/to the inside/outside of the water level detecting chamber P2, P12. With a simple structure, consequently, the water level in the water level detecting chamber P2, P12 can be maintained equivalent to the water level in the steam generating container 101, 201 and stably.

In a steam generating device 100, 200 according to an embodiment, a water supply/discharge port 107a, 207a through which water is to be supplied into and discharged from the steam generating container 101, 201 is provided in the steam generating container 101, 201.

According to the embodiment, water can be supplied and discharged through the water supply/discharge port 107a and 207a provided in the steam generating container 101, 201, and the structure can be simplified more greatly than that in the case in which a water supply port and a water discharge port are provided separately.

A steam generating device 100, 200 according to an embodiment includes a heat insulating cover 104, 204 formed at a distance with respect to the steam generating container 101, 201 so as to cover the steam generating container 101, 201 and fixed to the lid portion 102, 202.

According to the embodiment, the heat insulating cover 104, 204 formed at a distance with respect to the steam generating container 101, 201 so as to cover the steam generating container 101, 201 is fixed to the lid portion 102, 202. Consequently, an air heat insulating layer is formed between the steam generating container 101, 201 and the heat insulating cover 104, 204, and furthermore, heat conduction from the steam generating container 101, 201 to the lid portion 102, 202 is also lessened. Consequently, heat radiation from the steam generating container 101, 201 can be suppressed, so that the heating efficiency can be enhanced.

A thermal cooking apparatus according to an aspect of the present invention includes any one of the above-described steam generating devices 100 and 200; and a heating chamber 2 to which steam fed from the steam generating device 100, 200 is supplied.

According to the above structure, it is possible to enhance performance of the thermal cooking apparatus by using the steam generating device 100, 200 which is capable of suppressing the generation of scale and a reduction in the heating efficiency and capable of preventing water droplets and/or scale from being scattered into the heating chamber 2.

Furthermore, a thermal cooking apparatus according to an embodiment further includes an attaching member 120 by which the steam generating container 101, 201 of the steam generating device 100, 200 is attached through the lid portion 102, 202 to the heating chamber 2 or to an attached member provided on a side of the heating chamber 2.

According to the embodiment, the steam generating container 101, 201 of the steam generating device 100, 200 is attached to the heating chamber 2 through the lid portion 102, 202 by the attaching member 120. Therefore, it is possible to suppress the heat radiation from the steam generating container 101, 201 to the heating chamber 2, thereby enhancing the heating efficiency.

A thermal cooking apparatus according to an embodiment includes:

a heating chamber 2 to which steam fed from the steam generating device 100, 200 is supplied;

a body casing 1 in which the heating chamber 2 is accommodated; and

a cooling fan 54 arranged to cool an electrical component in the body casing 1,

wherein the heat insulating cover 104, 204 of the steam generating device 100, 200 has an opening portion 104a, 204a opened toward a downstream side of cooling air fed from the cooling fan 54, the opening portion 104a, 204a serving to lead, to an outside, a power supplying portion 103a, 203a of the heat source 103, 203 cast into the steam generating container 101, 201.

According to the embodiment, the power supplying portion 103a, 203a of the heat source 103, 203 cast into the steam generating container 101, 201 is led to the outside from the opening portion 104a, 204a of the heat insulating cover 104, 204 of the steam generating device 100, 200 by a wiring or the like. The opening portion 104a, 204a of the heat insulating cover 104, 204 is formed to be opened toward the downstream side of the cooling air fed from the cooling fan 54 for cooling an electrical component. Consequently, the cooling air fed from the cooling fan 54 does not enter the opening portion 104a, 204a of the heat insulating cover 104, 204. Therefore, it is possible to prevent a decrease in the temperature of the steam generating container 101, 201 through the cooling air.

The thermal cooking apparatus according to the present invention includes;

a heating chamber 2 for accommodating a food;

a steam generating device 100, 200 disposed on an outside of the heating chamber 2 for generating steam to be led to the heating chamber 2;

a water supply device (25, 26, 40, 43, 44) for supplying water to the steam generating device 100, 200; and

a heat source 103, 203 for heating the water supplied from the water supply device (25, 26, 40, 43, 44) to the steam generating device 100, 200,

the steam generating device 100, 200 having a steam generating container 101, 201 to which the water is supplied from the water supply device (25, 26, 40, 43, 44) and a lid portion 102, 202 for covering an upper opening of the steam generating container 101, 201,

the lid portion 102, 202 being made of a heat resistant resin or a portion between the steam generating container 101, 201 and the lid portion 102, 202 being heat insulated by a heat insulating member, and

the heat source 103, 203 being embedded in a bottom portion 101a, 201a of the steam generating container 101, 201.

According to the above structure, the steam generating device 100, 200 for generating steam to be led to the heating chamber 2 has the steam generating container 101, 201 to which the water is supplied from the water supply device (25, 26, 40, 43, 44) and the lid portion 102, 202 for covering the upper opening of the steam generating container 101, 201, and the heat source 103, 203 is embedded in the bottom portion 101a, 201a of the steam generating container 101, 201. Therefore, the water can be efficiently heated and evaporated by the steam generating container 101, 201 to be directly heated by the heat source 103, 203. The lid portion 102, 202 is made of the heat resistant resin or the portion between the steam generating container 101, 201 and the lid portion 102, 202 is heat insulated by the heat insulating member. Even if the water in the steam generating container 101, 201 is boiled and evaporated so that the inside of the steam generating space P1 formed by the steam generating container 101, 201 and the lid portion 102, 202 is filled with steam or boiling bubbles, therefore, the internal wall surface of the lid portion 102, 202 does not reach such a high temperature as to evaporate water droplets. Consequently, it is possible to suppress scale on the internal wall surface of the lid portion 102, 202. Thus, it is possible to suppress the generation of the scale and a reduction in the heating efficiency. Consequently, it is possible to prevent the water droplets and/or the scale from being scattered into the heating chamber 2. Accordingly, it is possible to perform excellent heat cooking using steam.

In a thermal cooking apparatus according to an embodiment, the heat source 103, 203 is embedded to be extended from one of the bottom portions 101a and 201a of the steam generating container 101 and 201 to the other, and at least a part of a bottom surface in the steam generating container 101, 201 is inclined along a direction in which the heat source 103, 203 is extended.

According to the embodiment, for example, the heat source 103, 203 is embedded in the longitudinal direction of the bottom portion 101a, 201a in the steam generating container 101, 201 which is slender as seen on a plane. Consequently, a slender sheath heater or the like can be disposed over a whole inside of the steam generating container 101, 201 so that the heating efficiency can be enhanced. In addition, for example, at least a part of the bottom surface in the steam generating container 101, 201 is inclined along the longitudinal direction where the heat source 103, 203 embedded in the bottom portion 101a, 201a of the steam generating container 101, 201 which is slender as seen on a plane is extended. Consequently, an inclined surface for collecting water into a water discharge port in water discharge can easily be formed in the bottom portion 101a, 201a in the steam generating container 101, 201. By providing the water discharge port in the lowest position of the inclined surface, it is possible to reliably discharge water in the steam generating container 101, 201 from the water discharge port.

In a thermal cooking apparatus according to an embodiment, the water supply port 107a, 207a for supplying water from the water supply device (25, 26, 40, 43, 44) into the steam generating container 101, 201 is provided in the steam generating container 101, 201 of the steam generating device 100, 200, the steam outlet 113a, 213a for supplying steam to the heating chamber 2 is provided in the lid portion 102, 202 of the steam generating device 100, 200, and at least a part of the bottom surface of the steam generating container 101, 201 is inclined in such a manner that the lower bottom surface portion of the water supply port 107a, 207a is lower than the lower bottom surface portion of the steam outlet 113a, 213a over the bottom surface in the steam generating container 101, 201.

According to the embodiment, at least a part of the bottom surface in the steam generating container 101, 201 is inclined in such a manner that the lower bottom surface portion of the water supply port 107a, 207a provided in the steam generating container 101, 201 is lowered. By using the water supply port 107a, 207a as a water discharge port, therefore, it is possible to reliably discharge the water in the steam generating container 101, 201 from the water discharge port.

In a thermal cooking apparatus according to an embodiment, the heat source 103, 203 is a U-shaped heater, and the U-shaped heater is embedded in the bottom portion 101a, 201a of the steam generating container 101, 201 in such a manner that a terminal portion 103a, 203a of the U-shaped heater is disposed on one of the water supply port 107a and 207a sides and a curved portion of the U-shaped heater is positioned on the other of the steam outlet 113a and 213a sides.

According to the embodiment, the U-shaped heater is embedded in the bottom portion 101a, 201a of the steam generating container 101, 201 in such a manner that the terminal portion 103a, 203a of the U-shaped heater to be the heat source 103, 203 is positioned on one of the water supply port 107a and 207a sides and a curved portion of the U-shaped heater is positioned on the other of the steam outlet 113a and 213a sides. At the water supply port 107a, 207a side of the U-shaped heater, consequently, a temperature on the terminal portion 103a, 203a side of the U-shaped heater, that is, the water supply port 107a, 207a side is lower as compared with the steam outlet 113a, 213a side of the U-shaped heater and the generation of boiling bubbles through boiling is less. Therefore, it is possible to suppress the flow of the steam out of the water supply ports 107a, 207a in the generation of steam.

In a thermal cooking apparatus according to an embodiment, at least a part of the bottom surface in the steam generating container 101, 201 is inclined in such a manner that a region opposed to a portion in which the temperature of the heat source 103, 203 is low is lower than a region opposed to a portion in which the temperature of the heat source 103, 203 is high in the bottom surface of the stem generating container 101, 201.

According to the embodiment, at least a part of the bottom surface in the steam generating container 101, 201 is inclined in such a manner that the opposed region to the portion in which the temperature of the heat source 103, 203 is low is lower than the opposed region to the portion in which the temperature of the heat source 103, 203 is high over the bottom surface in the steam generating container 101, 201. By providing the water discharge port in the vicinity of the opposed region to the portion in which the temperature of the heat source 103, 203 is low over the bottom surface in the steam generating container 101, 201, it is possible to prevent the water from being evaporated, resulting in generation of scale even if the water is discharged from the water discharge port immediately after the generation of the steam is completed.

In a thermal cooking apparatus according to an embodiment, the water supply device (25, 26, 40, 43, 44) has a water supply path 40 for supplying the water to the steam generating container 101, 201, and the water in the steam generating container 101, 201 is discharged through the water supply path 40.

According to the embodiment, the water in the steam generating container 101, 201 is discharged through the water supply path 40 of the water supply device (25, 26, 40, 43, 44). Consequently, it is possible to supply the water into the steam generating container 101, 201 and to discharge the water from the inside of the steam generating container 101, 201. Thus, it is possible to simplify the structure without requiring to provide a water discharge path separately.

In a thermal cooking apparatus according to an embodiment, the water supply device (25, 26, 40, 43, 44) has a pump 25 which is provided in the water supply path 40 and can switch a water supplying operation and a water discharging operation depending on a driving direction, the water is supplied from the water supply device (25, 26, 40, 43, 44) to the opposed region to the lowest part of the bottom surface in the steam generating container 101, 201 or the vicinity of the region by the pump 25 performing the water discharging operation through the water supply path 40, and the water is discharged through the water supply path 40 from the opposed region to the lowest part of the bottom surface in the steam generating container 101, 201 or the vicinity of the region by the pump 25 performing the water discharging operation.

According to the embodiment, the water is supplied from the water supply device (25, 26, 40, 43, 44) through the water supply path 40 to the opposed region to the lowest portion of the bottom surface in the steam generating container 101, 201 or the vicinity of the region by the pump 25 performing the water supplying operation. On the other hand, the water is discharged through the water supply path 40 from the opposed region to the lowest part of the bottom surface in the steam generating container 101, 201 or the vicinity of the region by the pump 25 performing the water discharging operation. Therefore, residual water in the steam generating container 101, 201 can be discharged reliably after the completion of the steam generation. Consequently, it is possible to supply and discharge the water through the water supply path 40 by the simple control for switching the driving direction of the pump 25.

### REFERENCE SIGNS LIST

1: body casing
2: heating chamber
2a: opening portion
3: door
4: magnetron
5: exhaust duct
6: dew receiver
7: outer glass
8: handle
9: operation panel
10: color liquid crystal display portion
11: button group
12: cancel key
13: start key
14: infrared ray receiving portion
15: a substance to be heated
16A, 16B: upper tray holder
17A, 17B: lower tray holder
18: circulation duct
19: circulation fan
20: upper heater
21: middle heater
22: lower heater
23: circulation damper
25: tube pump
26: water supply tank
27: suction port
28: upper outlet
29: first rear outlet
30: second rear outlet
31: third rear outlet
35: steam tube
36: steam pipe
37: steam supply port
40: water supply/discharge tube
41: water supply tank body
42: communicating pipe
43: tank cover
44: tank joint portion
45: natural exhaust port
46: first exhaust path
47: exhaust fan
48: forcible exhaust port
49: exhaust damper
50: air supply port
51: air supply damper
52: second exhaust path
53: steam sensor
54: air supply fan
55: air supply path
56: circulation fan motor
57: exhaust fan motor
58: air supply fan motor
59: circulation damper motor
60: exhaust damper motor
61: air supply damper motor
70: inside temperature sensor
80: control unit
91, 92: cooking tray
100: steam generating device
101: steam generating container
101a: bottom portion
102: lid portion
102a: body portion
102b: flange portion
102c: inserting portion
102d: protrusion
103: steam generating heater
103a: connecting terminal
104: heat insulating cover
105: water level sensor
105a, 105b: electrode
106: water level detecting chamber cover
107: water supply/discharge pipe
107a: water supply/discharge port
108: water supply/discharge port connecting portion
109: partition wall
110: boiling water shielding wall
111: seal member
102d: protrusion
113: steam outlet connecting portion
113a: steam outlet
120: attaching member
130: temperature fuse
140: steam generating temperature sensor
200: steam generating device
201: steam generating container
201a: bottom portion
202: lid portion
202a: body portion
202b: flange portion
202c: inserting portion
202d: protrusion
203: steam generating heater
203a: connecting terminal
204: heat insulating cover
205: water level sensor
205a, 205b: electrode
206: water level detecting chamber cover
207: water supply/discharge pipe
207a: water supply/discharge port
208: water supply/discharge port connecting portion
209: electrode cover portion
211: seal member
213: steam outlet connecting portion
213a: steam outlet
220: attaching member
230: temperature fuse
240: steam generating temperature sensor

1. A steam generating device comprising:
a heat source;
a steam generating container made of a metal having the heat source cast therein; and
a lid portion covering an upper opening of the steam generating container and forming a steam generating space together with the steam generating container,
the lid portion being made of a heat resistant resin or a portion between the steam generating container and the lid portion being heat insulated by a heat insulating member.

2. The steam generating device according to claim 1, wherein the lid portion has a protrusion provided on an upper side thereof and a steam outlet provided at an end of the protrusion, and the steam generating device further comprises, within the lid portion and at a lower side of the protrusion, a boiling water shielding wall provided in a region opposed to both the protrusion and a shoulder portion in the vicinity of the protrusion and serving to block boiling water from the steam generating container.

3. The steam generating device according to claim 1 further comprising:
a water level sensor arranged to detect a water level in the steam generating container; and
a water level detecting chamber cover provided in the steam generating space and forming a water level detecting chamber to surround the water level sensor.

4. The steam generating device according to claim 1, wherein a water supply/discharge port through which water is to be supplied into and discharged from the steam generating container is provided in the steam generating container.

5. The steam generating device according to claim 1, further comprising a heat insulating cover formed at a distance with respect to the steam generating container so as to cover the steam generating container and fixed to the lid portion.

6. A thermal cooking apparatus comprising:
the steam generating device according to claim 5;
a heating chamber to which steam fed from the steam generating device is to be supplied;
a body casing in which the heating chamber is accommodated; and
a cooling fan arranged to cool an electrical component in the body casing,
wherein the heat insulating cover of the steam generating device has an opening portion opened toward a downstream side of cooling air fed from the cooling fan, the opening portion serving to lead, to an outside, a power supplying portion of the heat source cast into the steam generating container.
